(19) United States
(12) Patent Application Publication
(10) Pub. No.: US 2012/0101711 A1
(43) Pub. Date: Apr. 26, 2012

(54) Collision Warning Apparatus

(75) Inventors: Paul Timothy Furmston, Warwickshire (GB); Mark Richard Tucker, Leicestershire (GB); Carl Shooter, Nottinghamshire (GB); John Martin Reeve, West Midlands (GB)

(73) Assignee: TRW LIMITED, Solihull (GB)

(21) Appl. No.: 13/148,116

(22) PCT Filed: Feb. 5, 2010
(86) PCT No.: PCT/GB2010/050189

§ 371 Date: Nov. 18, 2011

(30) Foreign Application Priority Data
Feb. 5, 2009 (GB) 0901906.8

(51) Int. Cl. G06F 7/00

(52) U.S. Cl. 701/300

(57) ABSTRACT

A collision warning apparatus for a host vehicle which has stopped along a lane of a highway, comprises at least one sensor associated with the host vehicle which generates a data stream in response to radiation received from a scene rearwards of the host vehicle, a memory in which the apparatus stores a reference target data set dependent upon movement of a first vehicle within the scene in a first period of time; and processing circuitry arranged to: identify a second target vehicle moving in the scene during a second period of time subsequent to the first period of time from the data stream and to output at least target data for the identified vehicle; and process the reference target data set with the target data or data derived therefrom, to determine whether there is a risk of collision between the second target vehicle and the host vehicle. The apparatus is especially suited for use with a vehicle that is stationary by the side of a road to warn of a possible collision from a vehicle that is approaching it from the rear.

### CROSS-REFERENCE TO RELATED APPLICATIONS

This application is a national stage of International Application No. PCT/GB2010/050189 filed Feb. 5, 2010, the disclosures of which are incorporated herein by reference, and which claimed priority to Great Britain Patent Application No. 0901906.8 filed Feb. 5, 2009, the disclosures of which are incorporated herein by reference.

### BACKGROUND OF THE INVENTION

This invention relates to collision warning apparatus adapted to identify the risk of a collision between a moving vehicle and a stationary vehicle. It is particularly suited to warning of collisions with stationary vehicles parked on or alongside a highway.

There are many instances where it is necessary for a vehicle to stop on or alongside a highway. A common example is the need for breakdown patrol vehicles to stop so that the driver can repair a broken down vehicle. Another example is the need for highway maintenance vehicles to stop alongside a highway to make repairs to the highway or to street furniture or perhaps to remove debris. The emergency services also often need to stop alongside highways.

Commonly highways with more than one lane are provided with safe refuge areas or a hard shoulder area which enables a vehicle to stop without occupying the lanes. This ensures that the traffic flowing along the lanes is not impeded and in theory should provide a degree of protection against collisions. Unfortunately it is a common occurrence for stationary vehicles and pedestrians in refuges or on the hard shoulder to be struck by vehicles that have strayed from the highway. The high forces involved often result in severe injuries to the vehicle occupants or those nearby.

### BRIEF SUMMARY OF THE INVENTION

An object of the present invention is to provide an apparatus that is able to identify moving vehicles which may be on course for a collision with a stationary vehicle and that may be used to initiate a warning of a collision. If a warning can be issued in time the driver of the moving vehicle on the collision course may be alerted and take evasive action. Any driver or passengers of the stationary vehicle may also be able to move safely out of the way of the collision, preventing injury.

According to a first aspect the invention provides a collision warning apparatus for a host vehicle which has stopped along a lane of a highway, comprising:

at least one sensor associated with the host vehicle which generates a data stream in response to radiation received from a scene rearwards of the host vehicle;
a memory in which the apparatus stores a reference target data set dependent upon movement of a first vehicle within the scene in a first period of time; and
processing circuitry arranged to:
identify a second target vehicle moving in the scene during a second period of time subsequent to the first period of time from the data stream and to output at least target data for the identified vehicle;
and process the reference target data set with the target data or data derived therefrom, to determine whether there is a risk of collision between the second target vehicle and the host vehicle.

The lane of the highway on which the host vehicle has stopped may be a refuge lane or a driving lane of the highway.

The at least one sensor may comprise a radar detector apparatus which is associated with the stationary vehicle and transmits radiation rearwards of the stationary vehicle. The captured data stream may comprise a series of radar echo signals corresponding to reflections from targets in the scene. These targets will include moving vehicles.

The radar sensor may have an active range of at least 100 metres and preferably 200 metres or more. It may be arranged to detect the presence, or absence, of any target vehicle at any speed up to at least 100 miles per hour and preferably 150 miles per hour or more. This enables targets to be identified and the risk of a collision determined while there is still time for the collision to be avoided or to provide enough warning for drivers and passengers of the stationary vehicle to move to safety.

Where a radar sensor is provided the processing circuitry may identify targets by processing the echo signals to determine how far that target is from the radar sensor and the lateral location of the targets. It may produce as its output three metrics: target vehicle speed, target vehicle distance (from the radar sensor) and target vehicle angular position.

Additionally or alternatively the at least one sensor may comprise a video camera and the captured data stream may comprise a stream of captured video images. The use of a video camera allows the estimation of the lane boundaries as they will be visible in the video image and can be extracted using, for example, edge detection algorithms. However, it is known that video is not as capable as radar at determining vehicle range so a combination of radar and video does provide some synergistic benefits. The targets may, for example, be indentified from radar data streams and the lane boundaries from video data streams.

The sensor may capture a sequence of data sets, each corresponding to a temporally spaced “image” of the scene, and the processing circuitry may determine the path that the or each target is following by comparison of the location of the identified targets in different images.

Target data may comprise data indicative of the position, velocity and yaw rate of the second target vehicle within the scene at a time within the second period of time. Velocity and yaw rate values provide more useful information than position alone on the future movement of a target vehicle. Yaw rate may be determined from the output of the radar sensor over a period of time by observing the change in a target's velocity vector.

While radar is able to detect the presence of moving targets from their reflections at any instant, it is not sufficient to predict the risk of collision based on velocity and position measurements at any one instant with no understanding of how the traffic is expected to move.

The applicant has appreciated that storing information about the movement of previous passing vehicles in a reference data set allows comparisons to be made between the movement of a target vehicle and other vehicles which have previously safely passed the host vehicle. Thus, it can be determined with more certainty if a target vehicle is moving in a safe way towards the host vehicle. The reference data set may comprise data indicative of the position, velocity and yaw rate of the first vehicle within the scene at a time within the first period of time.

Before the processing circuitry determines a risk of collision a reference data set may be stored. The processing circuitry may be arranged to generate the reference data set from the movement of the first vehicle which may be a vehicle moving within the scene rearward of the host vehicle.

Alternatively, the first vehicle may be the host vehicle prior to becoming stationary along a lane of a highway. The apparatus may prompt the driver of the host vehicle to drive a distance along the hard shoulder equivalent to a distance covered in the scene on which the sensor is directed. In order to generate the reference data set the host vehicle may include a motion sensor and the reference data set may be dependent upon the output of the motion sensor prior to the host vehicle becoming stationary. This allows a reference data set to be determined before the host vehicle comes to a stop so the system can provide collision warning for the first vehicle entering the scene. The apparatus may include a feed from a yaw sensor and/or wheel speed sensor which enables it to log the path, and an area of memory may be provided in which this information is logged. This information may provide an early indication of the position of a lane boundary and also the expected trajectory of moving vehicles. A switch or button may be provided which is operated by a driver to initiate the processing circuitry prior to the vehicle stopping.

The apparatus may in a still further variation log the path of the host vehicle using a GPS receiver or other satellite based positioning system to track the path of the vehicle prior to it stopping.

This could be used in addition to the estimate obtained by observing the paths of targets to improve the accuracy of the estimate or to provide an initial boundary estimate in the time before enough targets have passed to enable an estimate based on targets to have been made. The processing circuitry may be arranged to update the reference data set based on target data from a plurality of target vehicles, each moving through the scene at different periods of time prior to the current moment in time at which the reference data is updated. A more detailed picture can therefore be built up of the movement of vehicles through the scene rather than basing the collision prediction on the movement of the first vehicle through the scene.

The processing circuitry may be arranged to update the reference target data set based on an average of the target data for the plurality of target vehicles. This reduces the amount of data which needs to be stored and with only two sets of data to compare it, would reduce the processing demands. There are of course many other ways information on the movement of passing vehicles may be stored in the reference data set, for example data could be stored as probability distributions by assigning vehicle data taken at specific locations into bins. The bin with the largest amount of data would be representative of safe vehicle movement.

A target vehicle may be tracked as it moves through the scene such that the target data may comprise a plurality of sets of data, each set corresponding to a separate instant in time and indicating the path of the second target vehicle in the scene during the second period of time and its movement at a plurality of measured points along that path. The sets of data may also contain sufficient information to indicate the movement of the vehicle, e.g. speed and angle, at each of the set of points along that path.

In the embodiment where the first vehicle in the scene is a moving target, the first period of time starts when the host vehicle has stopped and the apparatus is activated.

In the alternative embodiment where the first vehicle in the scene is the host vehicle, the first period of time starts when the apparatus is activated before the host vehicle becomes stationary.

There are many different strategies that may be used to determine the risk of collision between the moving vehicle and the host vehicle. The processing circuitry, that determines the risk of collision, may be arranged to compare the target data with the reference target data set, and in the event that the comparison indicates that the second target vehicle is moving in a significantly different manner to the vehicle movement defined by the reference target data set the apparatus may be arranged to indicate that there is a risk of collision.

The processing circuitry determines that the data is significantly different if the velocity value of the target data exceeds the stored reference velocity by a predetermined amount and/or the yaw rate of the reference data set and/or the target data differ by increasing amounts.

Alternatively, the processing circuitry may be arranged to determine the risk of collision by assigning a safe region to the second target vehicle, the safe region encompassing a predicted future path of the second target vehicle through the scene and being bounded by a boundary, the predicted future path being determined with reference to the stored reference data set which defines a safe path, and the processor is adapted to adjust the boundary region dependent upon the difference between the target data set and the reference target data set, and further in which the processor is arranged to indicate a risk of collision in the event that the boundary region encompasses part of the host vehicle. The width of the safe region at a given point along the safe path in a direction normal to the direction of travel initially corresponds to half the width of a typical lane on a highway and increases in width as the amount by which a target vehicle deviates from the safe path increases.

In a further alternative, the processing circuitry may be further arranged to estimate the position of a lane boundary within the scene based on the reference data set and to determine if the second vehicle has crossed the lane boundary or is likely to cross the boundary by predicting the future path of the vehicle along the lane from the target data.

While radar is able to indentify moving targets from their reflections it is notably unable to observe lane boundaries because they are typically lines painted on a flat road surface and do not generate reflections that can be discriminated from the rest of the road surface. The data stream from the radar sensor cannot therefore readily be used to estimate the position of the lane boundaries.

However the applicant has appreciated that it is possible to infer the position of the lane boundary by monitoring the path followed by the first vehicle, assuming that the first vehicle will be generally driving within a lane of the highway, and mostly driving along the centre of the lanes. The lane boundary may then be defined by re-positioning the path within the scene. For instance, the lane boundary may be estimated to be spaced a predetermined distance to one side of the most extreme analysed path of a target vehicle, or a predetermined distance to the side of the stationary host vehicle. The reference data set may comprise an estimation of the position of a lane boundary in the scene and the processing circuitry may determine a risk of collision if the second target vehicle has crossed the lane boundary or is likely to cross the boundary by predicting the future path of the second target vehicle from the target data.

The processing circuitry may be adapted to identify moving vehicles whose path strays beyond the estimated lane boundaries by projecting the path that has been followed by the moving target vehicle forward along the highway to the point where the target is level with the stationary vehicle and determining if the vehicle is outside the lane boundaries at that point. This projection can be achieved based on the yaw rate of the moving vehicle and assuming the yaw rate will remain constant. Alternatively it may be achieved by comparing the path that has been followed with the path of a vehicle that would be safely moving along a lane, and only treating it as a threat if it deviates significantly from such an ideal safe path.

In addition the processing circuitry may be adapted to identify targets which are following an erratic course which may indicate that the vehicle is a threat. This includes behaviour such as meandering, violent steering movements, extreme acceleration activity and inaccurate steering control.

The processing circuitry initiates a signal to indicate a risk of collision when a risk of collision is identified. The processing circuitry may constantly calculate the probability of collision and only when the probability exceeds a certain threshold value will it initiate a warning signal.

The apparatus may generate a warning signal in the event that a high risk of collision is identified. The signal may activate various warning systems which may comprise an audible (e.g. vehicle horn) or visual warning (e.g. lights flashing/text display) or both. The warning may be issued in response to the signal output from the collision estimation means. In addition or as an alternative a safety device may be activated on the stationary vehicle or located to the rear of the vehicle. This may, for instance, comprise an inflatable airbag which may help dissipate energy in the event of the target colliding with the stationary vehicle.

According to a second aspect the invention provides a method of collision warning for a host vehicle which has stopped along a lane of a highway, comprising:

generating a data stream in response to radiation received from a scene rearwards of the host vehicle;
storing a reference target data set dependent upon movement of a first vehicle within the scene in a first period of time;
identifying a second target vehicle moving in the scene during a second period of time subsequent to the first period of time from the data stream and outputting at least target data for the identified vehicle; and
processing the reference target data set with the target data or data derived therefrom and determining whether there is a risk of collision between the second target vehicle and the host vehicle.

The target data may comprise data indicative of the position, velocity and yaw rate of the second target vehicle within the scene at a time within the second period of time.

The reference data set may comprise data indicative of the position, velocity and yaw rate of the first target vehicle within the scene at a time within the first period of time.

The processing may generate the reference data set from the movement of the first vehicle which is a vehicle moving within the scene rearward of the host vehicle.

The first vehicle within the scene may be the host vehicle prior to becoming stationary along a lane of a highway.

The host vehicle may include a motion sensor and the reference data set may be dependent upon the output of the motion sensor prior to the host vehicle becoming stationary.

The processing may update the reference data set based on target data from a plurality of target vehicles, each moving through the scene at different periods of time which precede the current moment in time at which the reference data is updated.

The processing may update the reference target data set based on an average of the target data for the plurality of target vehicles.

The target data may comprise a plurality of sets of data, each completed at separate instants in time and indicating the path of the second target vehicle in the scene during the second period of time and its movement at a plurality of points along that path.

The first period of time may start when the host vehicle has stopped and the apparatus is activated.

The first period of time may start when the apparatus is activated before the host vehicle becomes stationary.

The processing may compare the target data with the reference target data set, and in the event that the comparison indicates that the second target vehicle is moving in a significantly different manner to the vehicle movement defined by the reference target data set indicating that a collision may occur.

The processing may determine that the data is significantly different if the data indicative of velocity in the target data exceeds that stored in the reference data set by a predetermined amount and/or the yaw rate of the reference data set and/or the target data differ by a predetermined amount.

The processing may determine the risk of collision by assigning a safe region to the second target vehicle, the safe region encompassing a predicted future path of the second target vehicle through the scene and being bounded by a boundary, the predicted future path being determined with reference to the stored reference data set which defines a safe path, and the processing may adjust the boundary region dependent upon the difference between the target data set and the reference target data set, and further in which the processing may indicate a risk of collision in the event that the boundary region encompasses part of the host vehicle.

The width of the safe region at a given point along the safe path in a direction normal to the direction of travel may initially correspond to half the width of a typical lane on a highway and may increase in width as the amount by which a target vehicle deviates from the safe path at any point increases.

The reference data set may comprise an estimation of the position of a lane boundary in the scene and the processing determines a risk of collision if the second target vehicle has crossed the lane boundary or is likely to cross the boundary by predicting the future path of the second target vehicle from the target data.

The processing may initiate a signal to indicate a risk of collision when a risk of collision is identified.

The signal may activate various warning systems.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a representation of a vehicle with a first embodiment of a warning apparatus mounted on the rear of the vehicle's roof in accordance with the first aspect of the present invention;

FIG. 2 shows in a schematic view the radar collision warning apparatus of FIG. 1;

FIG. 3 shows the problem of false alarms being raised when only instantaneous velocity data is used;

FIG. 4 shows an example of the functions carried out by the processing circuitry in the controller of FIG. 2;

FIG. 5 shows an example of a flowchart for the process of obtaining the initial reference data set in FIG. 4;

FIG. 6 shows an example of how a moving vehicle's velocity and yaw rate may be used to determine the risk of collision in step 404 of FIG. 4 by predicting the future movement of a moving vehicle;

FIG. 7 shows an alternative example of how to determine the risk of collision in step 404 of FIG. 4 by assigning variable boundaries to a moving vehicle;

FIG. 8 shows a further alternative example of how to determine the risk of collision in step 404 of FIG. 4, by predicting the position of a lane boundary;

FIG. 9 shows a schematic view of a second embodiment of a warning apparatus in accordance with the present invention;

FIG. 10 shows an example of a flowchart for the processes the apparatus of FIG. 9 may use to obtain the initial reference data set before the host vehicle comes to a stop;

FIG. 11 shows a third embodiment of a collision warning apparatus which utilises a video camera and imaging recognition as the sensor device;

FIG. 12 shows an arrangement of a fourth embodiment that utilises a combined video and radar sensor apparatus; and

FIG. 13 shows a modification for supporting the warning apparatus of any previous embodiment on a tripod behind the stationary host vehicle.

### DETAILED DESCRIPTION OF THE INVENTION

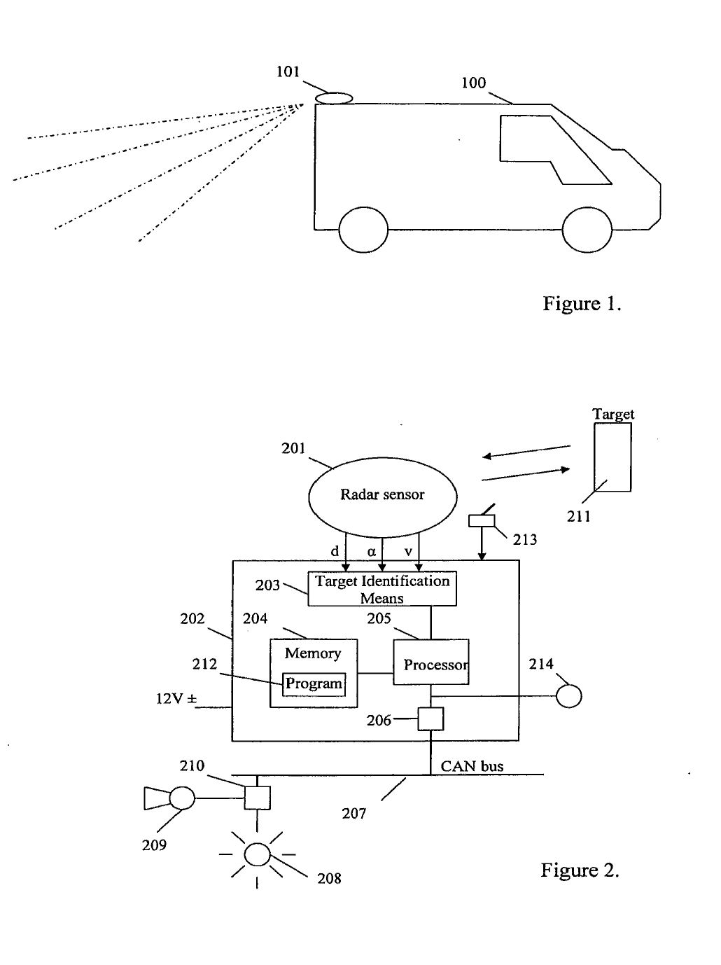

A first embodiment of a collision warning apparatus in accordance with the first aspect of the invention is illustrated in FIG. 1 of the accompanying drawings. A host vehicle 100 which is stationary alongside a highway, supports a rearward-looking sensor 101 which is provided substantially on the rear of the vehicle at the highest attainable position to obtain the best view of the oncoming traffic within the scene on which it is directed. The apparatus would be desirable in the situation where the host vehicle is a maintenance vehicle is parked on the hard-shoulder or refuge lane of a multilane highway to provide the maintenance workers and oncoming drivers a warning of a potential collision between their vehicles. In certain situations the field of view may need to be changed so the lanes of moving traffic and the hard-shoulder are viewed rather than the roadside verge.

In this first embodiment the sensor is a radar sensor 101 which emits and then receives reflected signals returned from surfaces of target vehicles travelling towards the stationary host vehicle. The radar unit in this example is able to detect and monitor a number of vehicles at any one time. An example of such a radar unit is the AC20 radar available from Conekt by TRW.

The first embodiment is shown in schematically in FIG. 2, the apparatus is activated with switch 213 which causes the radar sensor 201 to provide as an output a data stream comprising relative velocity (v), distance (d) and angular position (a) measurements of vehicles 211 moving within the scene. This data stream is fed to the input of a controller 202 which contains the processing circuitry linked to the memory. The controller 202 comprises a target identification means 203, a processor 205, a memory 204 and a program 212 which is stored in the memory 204. If the controller 202 determines a risk of collision it can generate a signal which may be communicated along the vehicle's CAN bus 207 through transceivers 206 and 210 to activate integral warning systems on the vehicle such as the horn 209 or the lights 208. Alternatively, the processor may communicate with other separate warning systems 214.

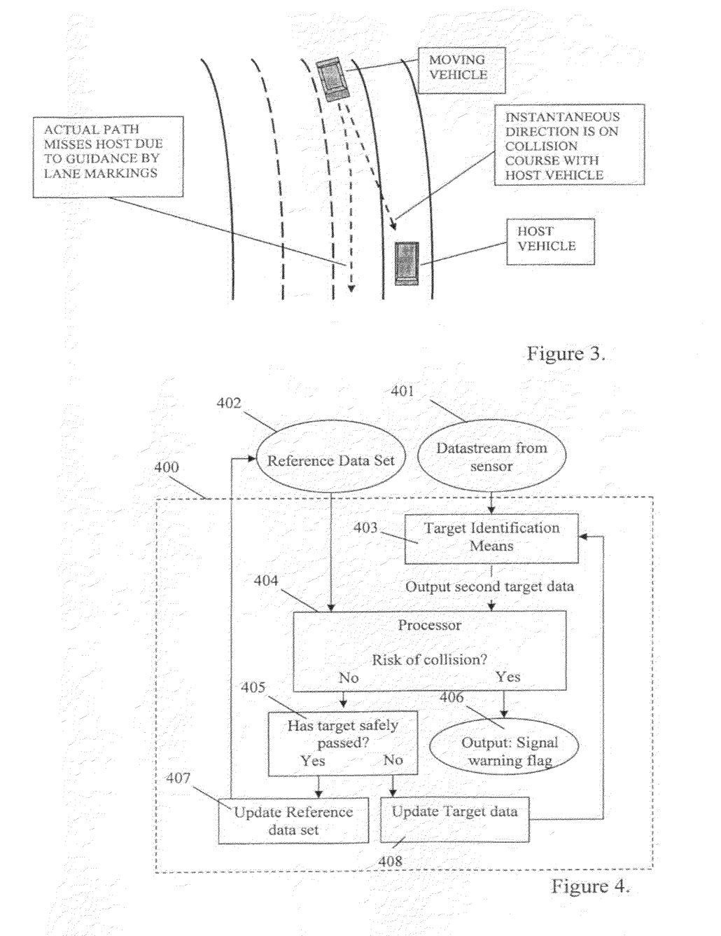

The radar sensor 201 is capable of inferring the velocity, angular position and distance of targets moving along a road towards the stationary vehicle. However, this alone is insufficient to accurately predict if any of the moving vehicles are on a collision course with the stationary vehicle, as shown in FIG. 3, because radar has no vision of the road markings which would indentify that the moving vehicle 301 is on an expected path and driving around a bend. Without an understanding of the expected path of passing vehicles, systems basing collision prediction on instantaneous position and velocity measurements are likely to raise many false alarms.

FIG. 4 shows a flow chart of the functions carried out by processing circuitry 400 of the first embodiment. The processor 404 has two inputs being a reference data set 402 which is stored in the memory and target data which is output from the target identification means 403. The target data contains measurements of a target vehicle's velocity, position and yaw rate at time intervals as the target moves through the scene. Velocity and position can be determined at an instant from the datastream output from the radar unit. Yaw rate is estimated by looking at several snap-shots at separate time instances to see how a vehicle's velocity vector changes with time from which the change in direction over time can be determined.

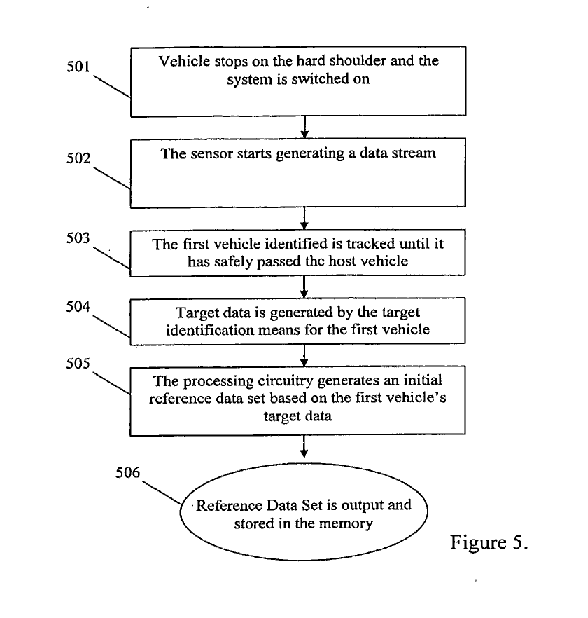

In the first embodiment, the reference data set is determined from target data taken from at least one vehicle which has safely passed the host vehicle. The reference data set is generated from position, velocity and yaw rate measurements in the target data which provide information on how a vehicle is expected to move within the scene. The position measurements define safe paths of passing vehicles, while velocity and yaw rate measurements indicate the future movements of a target vehicle so that a collision warning may be raised before a vehicle leaves a safe path. Before the apparatus can provide collision warning it must first generate a reference data set. In this example the reference data is generated in a first period of time after the host vehicle has stopped next to the highway where the apparatus is activated as shown in step 501 of FIG. 5. The radar unit will then start generating the data stream in step 502 and the target identification means will start identifying vehicles. After the first vehicle has safely passed the host vehicle the apparatus will generate a reference data set based that first vehicle's target data in steps 503-506. As more vehicles safely pass, their target data will add to the reference data set to improve the definition of safe movement according to step 407 of FIG. 4.

With a reference data set 402 stored the processing circuitry 400 is able to provide warning of collision between the host vehicle and another identified target vehicle moving within the scene at a second subsequent period of time. As the target vehicle moves into the scene target data will be produced by the target identification means 403. At a number of instants during the vehicle's movement through the scene the processor 404 will determine the risk of collision by taking the target data and comparing it to the reference data set, should a risk of collision be determined a warning signal is raised in step 406. If no risk of collision is identified then the system will determine, in step 405, if the target has safely passed the host and left the scene. If the vehicle is still within the scene then the target data will be updated with measurements from another instant in time, in step 408, and the risk of collision is re-determined. Once the target vehicle has safely passed the host vehicle then the target data is used to update the reference data set.

The processing circuitry can track more than one second vehicle at once by parallel processing multiple sets of target data per second vehicle and can perform this function indefinitely.

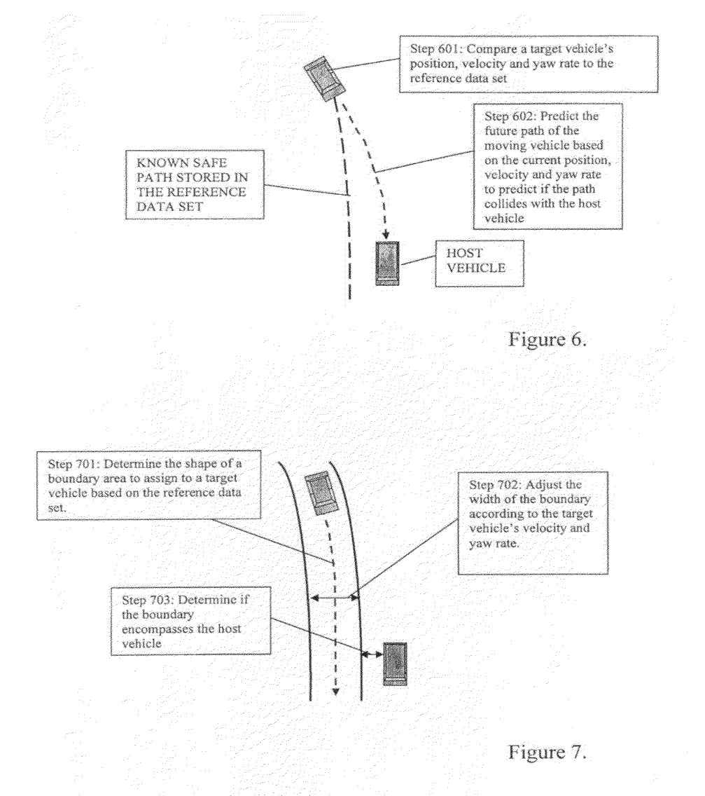

Yet more specifically for this example, the operation of the processing circuitry determining the risk of collision can be summarised as follows (in FIG. 6):

Step 601: Compare the target vehicle's position, velocity and yaw rate to the reference data set to determine if the vehicle is moving in a characteristic way of previous passing vehicles, if the vehicle is moving as expected then repeat step 601 until the vehicle has left the scene, if it is not then proceed to step 602.
Step 602: Predict the future path of the moving vehicle based on the current position, velocity and yaw rate, if the predicted path crosses the vehicle a collision risk is identified, if not then repeat step 601.

In a modification to the first embodiment, the processing circuitry may be arranged to determine the risk of collision by the method as summarised in FIG. 7.

Step 701: Determine the shape of a boundary area to assign to a target vehicle based on the reference data set which contains a stored path for passing vehicles.
Step 702: Adjust the width of the boundary according to the target vehicle's velocity and yaw rate, the larger the velocity and yaw rate the larger the boundary.
Step 703: Determine if the boundary encompasses or encroaches the host vehicle, if it does then a risk of collision is identified, if not then repeat step 701 at a later time instant.

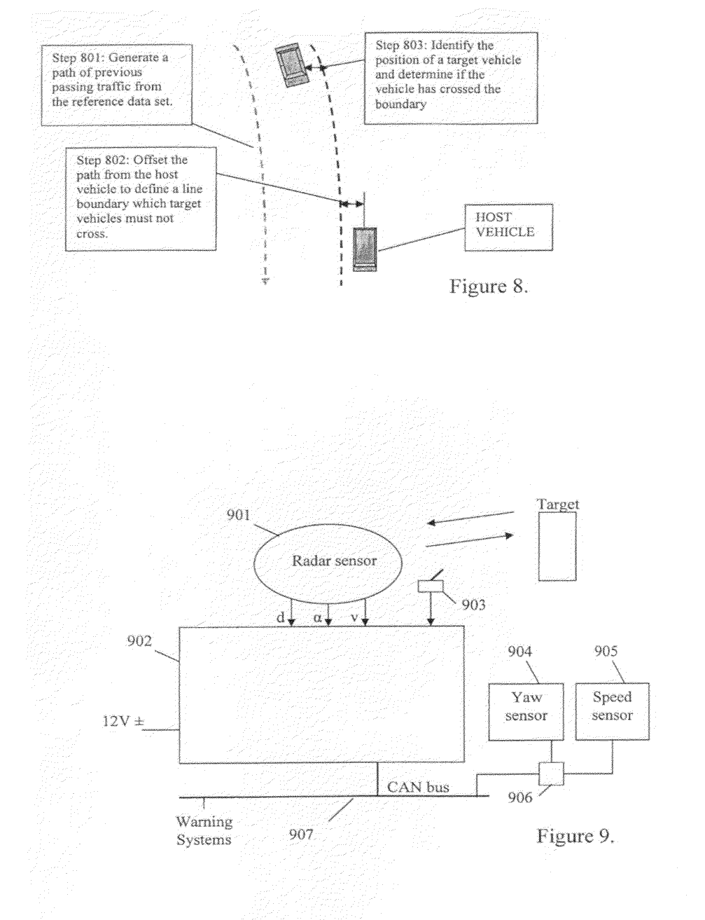

In a further modification to the first embodiment, the processing circuitry may determine the risk of collision by the method as summarised in FIG. 8.

Step 801: Generate a path of previous passing traffic from the reference data set.
Step 802: Offset the path from the host vehicle to define a line boundary which target vehicles must not cross.
Step 803: Identify the position of a target vehicle and determine if the vehicle has crossed the boundary to identify a risk of collision.

One possible limitation of this apparatus is that it will be unable to provide warnings of vehicles drifting into the hard shoulder until target data has been obtained from one target vehicle passing the host vehicle and if that target vehicle is following a path inconsistent with the following traffic false collision warnings may be initiated.

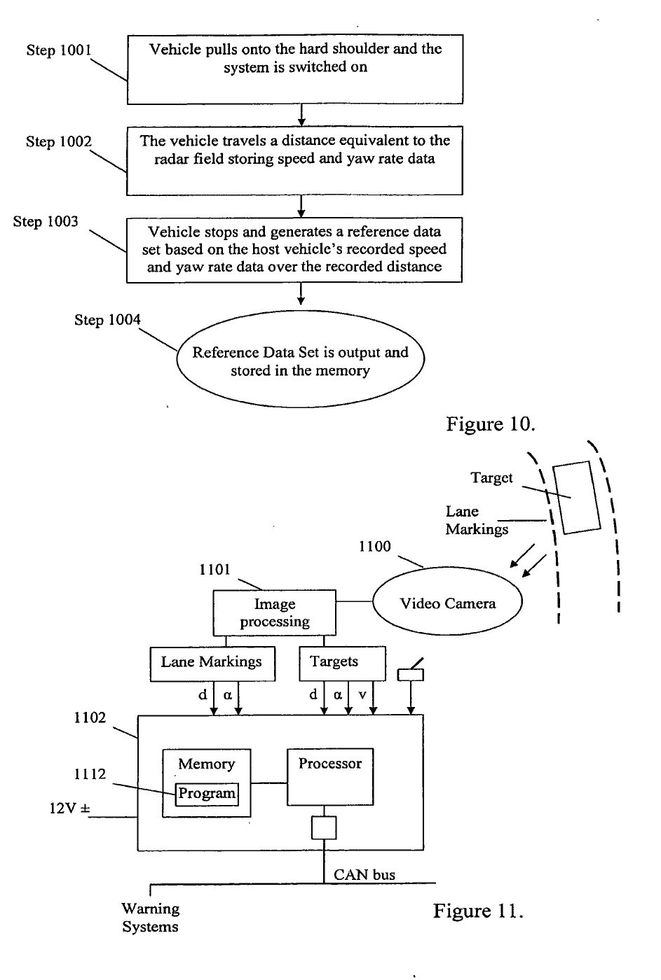

A second embodiment of a collision warning apparatus in accordance with the first aspect of the invention is illustrated in FIG. 9. This embodiment gathers a reference data set before the host vehicle stops next to the highway, so it has the advantage of being able to assess the risk of collision when the first target vehicle enters the scene. The reference data set is generated from additional yaw 904 and speed 905 sensors which monitor the host vehicle's final movements before it comes to a stop. The radar sensor 901 is the same as the previous embodiment as is the processing circuitry in the controller 902, only now the processing circuitry is able to receive signals from the yaw 904 and speed 905 sensors. The switch 903 should be used to activate the apparatus as the vehicle pulls onto the hard shoulder so that information can be recorded from the yaw sensor 904 and wheel speed sensor 905 to map the final movements of the vehicle. These sensors may be integral in the vehicle where they can communicate information through a transceiver 906 on the vehicle CAN bus 907 or alternatively they may be integral in the radar unit 901. A reasonable approximation of the expected path of the moving traffic can be obtained by following the sequence in FIG. 10.

Step 1001: The host vehicle pulls onto the hard should and the system is switched on.
Step 1002: The host vehicle then drives a distance down the hard shoulder equivalent to the radar field, while storing data on its the speed and yaw rate.
Step 1003: The vehicle stops and generates a reference data set based on the data recorded in step 1002. Note that the vehicle path will typically be parallel to the path defined by the reference data set.
Step 1004: The reference data set is stored in the memory before the host vehicle comes to a stop, where it generates a reference data set.

The apparatus can then directly start monitoring target vehicles in the same manner as the first embodiment. This initial gathering of data could also be obtained through other means such as GPS positioning with an accurate map. The stationary vehicle can be located on the map which will indicate its location in the road layout at that point. The apparatus would determine the expected path of vehicles as they approach the stationary vehicle from the curvature of the road on the map.

FIG. 11 shows a third embodiment of the invention for an apparatus where the at least one sensor is a video camera 1100 which provides images of the road scene to an image processor 1101. Image processing and edge recognition is well known in the art for detecting white road markings and relating vehicle movement relative to those lines. The camera 1100 sends images to the image processing unit 1101 which identifies the lane markings and target vehicles within the image. The image processing unit 1101 is able to determine the time to intersection of a moving vehicle through a technique that finds the rate of change of size of a vehicle's image. The location of the vehicle in the image provides information on the angular position. The range of the vehicle from the camera is inferred from the expected size of a vehicle which is based on visual characteristics such as the position of the number plate and relative dimension ratios. The position and velocity of target vehicles is fed into the control unit 1102 which has the same contents as the controller in the first embodiment only now it is adapted to receive information on moving targets and lane markings. This system generates the initial reference data set based on the positions of road markings; this means the apparatus can be functional as soon as the apparatus is switch on once the vehicle is stationary by comparing the position of approaching vehicles to the lane markings. Its disadvantage is that it cannot be used at night or in poor visibility conditions.

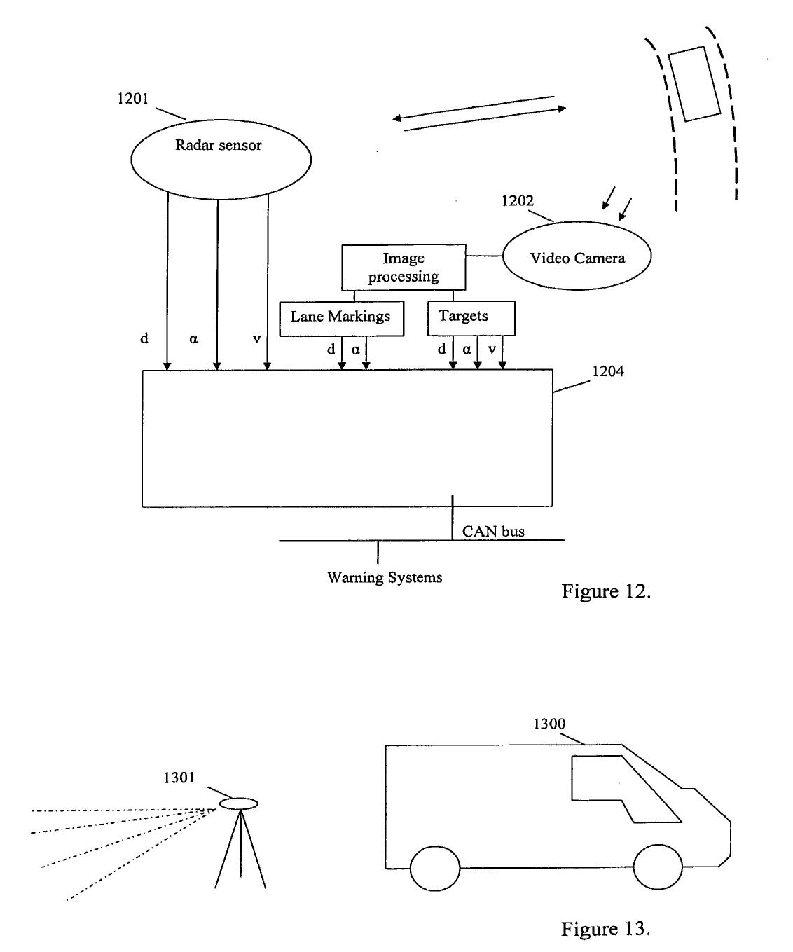

FIG. 12 shows a fourth embodiment of the invention for an apparatus where the at least one sensor combines the use of radar 1201 and video 1202 sensors. A video based apparatus alone has the limitation that: it cannot function well in poor visibility conditions such as at night or in foggy conditions; it is not intrinsically suited to velocity measurement, though rough measurements can be inferred from visual images and it is generally not suited to long range measurement. While the radar based apparatus is unable to reach full functionality until it has monitored a number of passing vehicles. Combining the two sensors has the advantage of the excellent range and speed measurements of radar and the improved lateral position measurements from the video sensor. This leads to improved estimates of vehicle yaw and correspondingly the vehicle trajectories within the controller 1204, which exceed the capabilities of an apparatus containing one of the sensor types. The apparatus would also be able to reach full protection capability quicker by initially making use of the video to identify the road markings providing a good estimate for the expected vehicle paths. If the road conditions where to the detriment of the video sensor then the radar sensor could still provide protection as identified in the first embodiment. In good visibility the combined sensor apparatus would be a significant enhancement to an apparatus with radar only or video only.

As shown in FIG. 13, the apparatus may comprise a free standing tripod 1301 behind the stationary vehicle 1300 to support all or part of the warning apparatus. This modification may be applied to any of the described embodiments. A connection can be made with the vehicle to activate warning systems on the vehicle or warning systems can be attached to the tripod. The advantage of the tripod is that the warning apparatus can be easily interchanged between vehicles.

There are many methods that could be used to warn individuals of a likely collision with the host vehicle. These warning are not only directed at the occupants of the host vehicle but also to the oncoming target vehicle that they are in danger of colliding with. Thus, both parties have a chance to take evasive action to avoid the collision. Common warning methods include: sounding the vehicle horn; sounding auxiliary audible warnings via voice or siren; flashing vehicle indicators or lights; using in-vehicle audio warnings; interior lamps; strobe lighting and illuminating signs. Other interfaces could also include: mobile phones; hand-held computers and bespoke portable devices. These devices can use wireless technology to trigger the warning in a location immediate to the users.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A collision warning apparatus for a host vehicle which has stopped along a lane of a highway, comprising:
a memory in which said apparatus stores a reference target data set dependent upon movement of a first vehicle within said scene in a first period of time;
at least one sensor associated with said host vehicle which generates a data stream in response to radiation received from a scene rearwards of said host vehicle; and
processing circuitry arranged to:
identify a second target vehicle moving in said scene during a second period of time subsequent to said first period of time from said data stream and to output at least target data for said identified vehicle, said processing circuitry further arranged to process said reference target data set with said target data to determine whether there is a risk of collision between said second target vehicle and said host vehicle.

2. A collision warning apparatus according to claim 1 wherein said target data includes data indicative of a position, velocity and yaw rate of said second target vehicle within the scene at a time within said second period of time.

3. A collision warning apparatus according to claim 1 wherein said reference data set includes data indicative of a position, velocity and yaw rate of said first vehicle within the scene at a time within said first period of time.

4. A collision warning apparatus according to claim 3 wherein said first vehicle is a vehicle moving within said scene rearward of said host vehicle.

5. A collision warning apparatus according to claim 3 wherein said first vehicle is said host vehicle prior to said host vehicle becoming stationary along a lane of a highway.

6. A collision warning apparatus according to claim 5 wherein said host vehicle includes a motion sensor and said reference data set is dependent upon the output of said motion sensor prior to the host vehicle becoming stationary.

7. A collision warning apparatus according to claim 1 wherein said processing circuitry is arranged to update the reference data set based on target data from a plurality of target vehicles, each target vehicle moving through said scene at different periods of time which precede a moment in time at which said reference data set is updated.

8. A collision warning apparatus according to claim 7 wherein said processing circuitry is arranged to update said reference target data set based on an average of said target data for said plurality of target vehicles.

9. A collision warning apparatus according to claim 2 wherein said target data comprises a plurality of sets of data, each set corresponding to a separate instant in time and indicating a path of said second target vehicle in said scene during said second period of time and its movement at a plurality of measured points along said path.

10. A collision warning apparatus according to claim 1 wherein said first period of time starts when said host vehicle has stopped and said apparatus is activated.

11. A collision warning apparatus according to claim 1 wherein said first period of time starts when said apparatus is activated before said host vehicle becomes stationary.

12. A collision warning apparatus according to claim 3 wherein said processing circuitry, is arranged to compare said target data with said reference target data set, and in the event that said comparison indicates that said second target vehicle is moving in a significantly different manner to a vehicle movement defined by said reference target data set, the apparatus is arranged to indicate that a collision may occur.

13. A collision warning apparatus according to claim 3 wherein said processing circuitry determines that said target data set and reference data set are significantly different if the data indicative of velocity in said target data exceeds that stored in said reference data set by a predetermined amount by at least one of:
(a) the yaw rate of the reference data set and
(b) the target data differ by increasing amounts.

14. A collision warning apparatus according to claim 1 wherein said processing circuitry is arranged to determine said risk of collision by assigning a safe region to said second target vehicle, said safe region encompassing a predicted future path of said second target vehicle through said scene and being bounded by a boundary, said predicted future path being determined with reference to said stored reference data set which defines a safe path with said processing circuitry being adapted to adjust said boundary region dependent upon the difference between said target data set and said reference target data set, and further wherein said processing circuitry is arranged to indicate a risk of collision in the event that said boundary region encompasses part of said host vehicle.

15. A collision warning apparatus according to claim 14 wherein said said safe region has a width at a given point along said safe path in a direction normal to said direction of travel that initially corresponds to half of a width of a typical lane on a highway and increases in width as second vehicle moves further away from said safe path.

16. A collision warning apparatus according to claim 1 wherein said reference data set includes an estimation of a position of a lane boundary in said scene and said processing circuitry determines a risk of collision if said second target vehicle has crossed said lane boundary or is likely to cross said lane boundary by predicting a future path of said second target vehicle from said target data.

17. A collision warning apparatus according to claim 1 wherein said processing circuitry initiates a signal to indicate a risk of collision when a risk of collision is identified.

18. A collision warning apparatus according to claim 17 wherein said signal activates various warning systems.

19. A method of collision warning for a host vehicle which has stopped along a lane of a highway, comprising:
storing a reference target data set dependent upon movement of a first vehicle within a scene in a first period of time;
generating a data stream in response to radiation received from said scene rearwards of said host vehicle;
identifying a second target vehicle moving in the scene during a second period of time subsequent to said first period of time from said data stream and outputting at least target data for said second target vehicle; and
processing said reference target data set with said target data to determine whether there is a risk of collision between said second target vehicle and said host vehicle.

20. A method according to claim 19 wherein said target data includes data indicative of a position, velocity and yaw rate of said second target vehicle within said scene at a time within said second period of time.

21. A method according to claim 19 wherein said reference data set includes data indicative of a position, velocity and yaw rate of said first target vehicle within said scene at a time within said first period of time.

22. A method according to claim 21 which further includes generating said reference data set from a movement of said first vehicle which is a vehicle moving within said scene rearward of said host vehicle.

23. A method according to claims 19 wherein said first vehicle within said scene is said host vehicle prior to becoming stationary along a lane of a highway.

24. A method according to claim 23 wherein said host vehicle includes a motion sensor and said method further includes producing a reference data set that is dependent upon an output of said motion sensor prior to said host vehicle becoming stationary.

25. A method according to claim 19 which further includes updating said reference data set based on target data from a plurality of target vehicles, each target vehicle moving through said scene at different periods of time which precede a current moment in time at which said reference data set is updated.

26. A method according to claim 25 which further includes updating said reference target data set based on an average of target data for said plurality of target vehicles.

27. A method according to claim 20 wherein said target data includes a plurality of sets of data, each determined at separate instants in time and indicating the path of said second target vehicle in said scene during said second period of time and its movement at a plurality of points along that path.

28. A method according to claim 19 wherein said first period of time starts when said host vehicle has stopped and said apparatus is activated.

29. A method according to claims 19 wherein said first period of time starts when said apparatus is activated before said host vehicle becomes stationary.

30. A method according to claim 19 which further includes comparing said target data with said reference target data set, and in the event that said comparison indicates that said second target vehicle is moving in a significantly different manner to said vehicle movement defined by said reference target data set indicating that a collision may occur.

31. A method according to claim 30 further including determining that said data is significantly different in at least one of the following cases:
(a) that the data indicative of velocity in said target data exceeds that stored in said reference data set by a predetermined amount; and
(b) that the data is indicative of yaw rate in the target data set differs from the yaw rate of the reference data set by increasing amounts.

32. A method according to claim 19 further including determining the risk of collision by assigning a safe region to said second target vehicle, said safe region encompassing a predicted future path of said second target vehicle through said scene and being bounded by a boundary, said predicted future path being determined with reference to said stored reference data set which defines a safe path, and adjusting said safe boundary region dependent upon the a difference between said target data set and said reference target data set, and further in which the method includes indicating a risk of collision in the event that said boundary region encompasses part of said host vehicle.

33. A method according to claim 32 wherein a width of said safe region at a given point along a safe path in a direction normal to a direction of travel initially corresponds to half a width of a typical lane on a highway and increases in width as said difference increases.

34. A method according to claim 19 which reference data set includes an estimation of the position of a lane boundary in said scene and a determination of a risk of collision if said second target vehicle has crossed a lane boundary or is likely to cross a lane boundary by predicting a future path of said second target vehicle from said target data.

35. A method according to claim 19 further including initiating a signal to indicate a risk of collision when a risk of collision is identified.

36. (canceled)

37. (canceled)

38. A collision warning apparatus according to claim 12 wherein said processing circuitry determines that said target data set and reference data set are significantly different if the data indicative of velocity in said target data exceeds that stored in said reference data set by a predetermined amount or by at least one of:
(a) the yaw rate of the reference data set and
(b) the target data differ by increasing amounts.
